(19) United States
(12) Patent Application Publication
(10) Pub. No.: US 2026/0105517 A1
(43) Pub. Date: Apr. 16, 2026

(54) CONSUMER FACILITY AND SERVICE PLATFORM FOR ELECTRIC POWER TRADING

(71) Applicants: HYUNDAI MOTOR COMPANY, Seoul (KR); KIA CORPORATION, Seoul (KR)

(72) Inventors: Jong Won Kim, Hwaseong-si (KR); Jung Hyun Noh, Hwaseong-si (KR)

(73) Assignees: HYUNDAI MOTOR COMPANY, Seoul (KR); KIA CORPORATION, Seoul (KR)

(21) Appl. No.: 19/201,877

(22) Filed: May 7, 2025

(30) Foreign Application Priority Data
Oct. 11, 2024 (KR) 10-2024-0138633

(51) Int. Cl. G06Q 40/04; G06Q 50/06

(52) U.S. Cl. CPC G06Q 40/04; G06Q 50/06

(57) ABSTRACT

A consumer facility for electric power trading is provided. The consumer facility includes one or more processors, and a storage medium configured to store a computer-readable instruction. When the computer-readable instruction is executed by the one or more processors, the one or more processors are configured to transmit service registration information for electric power trading, and transmit an electric power trading request, the electric power trading request including electric power to purchase, among eco-friendly electric power and general electric power, and a power capacity to purchase, when a service registration confirmation is received in response to transmission of the service vehicle registration information, and electric power corresponding to the power capacity to purchase is withdrawn from a service platform according to the electric power trading request.

### CROSS-REFERENCE TO RELATED APPLICATION(S)

This application claims the benefit of priority to Korean Patent Application No. 10-2024-0138633 filed on Oct. 11, 2024, in the Korean Intellectual Property Office, the disclosure of which is incorporated herein by reference in its entirety.

### TECHNICAL FIELD

The present disclosure relates to a consumer facility and service platform for electric power trading.

### BACKGROUND

Recently, as environmental regulations in various countries have been strengthened, the RE100 campaign is underway. The RE100 campaign is a campaign to cover 100% of electric power, used by companies, using eco-friendly electric power. Here, eco-friendly electric power may refer to electric power, generated by renewable energy sources such as solar power, wind power, and the like.

However, RE100 is still based on voluntary commitments, rather than legal obligations. As such, it may be useful to induce voluntary participation from the trading parties. To this end, it may be useful to trade eco-friendly electric power and general electric power separately.

### SUMMARY

An aspect of the present disclosure provides a consumer facility and a service platform for electric power trading, capable of inducing voluntary participation in the RE100 campaign.

According to an aspect of the present disclosure, there is provided a consumer facility for electric power trading. The consumer facility includes one or more processors, and a storage medium configured to store a computer-readable instruction. When the computer-readable instruction is executed by the one or more processors, the one or more processors may be configured to transmit service registration information for electric power trading, and may be configured to transmit an electric power trading request. The electric power trading request may include electric power to purchase, among eco-friendly electric power and general electric power, and a power capacity to purchase, when a service registration confirmation is received in response to transmission of the service vehicle registration information. Electric power corresponding to the power capacity to purchase is withdrawn from a service platform according to the electric power trading request.

The consumer facility may further include a first energy storage system (ESS) configured to store the eco-friendly electric power and the general electric power, and a first state information storage unit configured to store first state information of the first ESS. The first state information may include a total power capacity (TPC), a remaining power capacity (RPC) of the eco-friendly electric power, and a remaining power capacity (RPC) of the general electric power in addition to information including a temperature and a state of charge (SOC) of the first ESS.

The service registration information may include cooling performance information on the first ESS. A withdrawal speed of electric power withdrawn from the service platform may be limited based on the cooling performance information and the temperature of the first ESS.

The one or more processors may be configured to update the first state information.

The one or more processors may be configured to receive a request for the first state information, to transmit the first state information in response to the received request for the first state information, and to receive purchasable power capacity information. The purchasable power capacity information may include a power capacity of each of the eco-friendly electric power and the general electric power, after the first state information is transmitted.

The one or more processors may be configured to receive the updated first state information.

The one or more processors may be configured to request unit price information for each unit of electric power. The unit price for each unit of electric power may include a unit price of each of the eco-friendly electric power and the general electric power. The one or more processors may be configured to receive the unit price information for each unit of electric power, after the unit price information for each unit of electric power is requested.

The eco-friendly electric power may be electric power, generated and stored by a renewable energy source. The general electric power may be electric power, generated and stored using a fossil fuel.

The general electric power may be electric power, charged by one of rapid charging, slow charging, or overnight charging.

The renewable energy source may be at least one of solar power and regenerative braking.

The service registration information may include at least one of registrant information including a service registrant and a code of the registrant, and cooling performance information including cooling performance of the first ESS.

The consumer facility may be a vehicle including a solar panel for generating electric power by solar power.

The one or more processors may be configured to subtract, according to a predetermined priority between the eco-friendly electric power and the general electric power, a power capacity (e.g., required) to drive a motor or a power capacity (e.g., required) to drive an electrical load from an REC of corresponding electric power, when the motor or the electrical load is driven.

The service registration information may further include vehicle information including a manufacturer and a year of the vehicle.

According to another aspect of the present disclosure, there is provided a service platform for electric power trading. The service platform may include one or more processors, and a storage medium configured to store a computer-readable instruction. When the computer-readable instruction is executed by the one or more processors, the one or more processors may be configured to receive service registration information, to transmit a service registration confirmation in response to the received service registration information, to receive an electric power trading request, the electric trading request including electric power to be purchased by a consumer facility, among eco-friendly electric power and general electric power, and a power capacity to be purchased, after the service registration confirmation is transmitted, and to withdraw electric power corresponding to the power capacity to be purchased, according to the electric power trading request.

The service platform may further include a second ESS configured to store the eco-friendly electric power and the general electric power, and a second state information storage unit configured to store state information of the second ESS. The second state information may include a TPC, a RPC of the eco-friendly electric power, and a RPC of the general electric power in addition to information including a temperature and an SOC of the second ESS.

The service registration information may include cooling performance information on a first ESS included in the consumer facility. The one or more processors may be configured to limit a withdrawal speed of electric power withdrawn from the first ESS, based on the cooling performance information and a temperature of the first ESS.

The one or more processors may be configured to update first state information of the first ESS, and to transmit the updated first state information to the consumer facility.

The one or more processors may be configured to receive a request for unit price information for each unit of electric power, the unit price information for each unit of electric power including a unit price of each of the eco-friendly electric power and the general electric power, and to transmit the unit price information for each unit of electric power in response to the request.

The one or more processors may be configured to request a trading price from the consumer facility, and to receive the trading price from the consumer facility. When the electric power to be purchased is eco-friendly electric power, the trading price may be a value obtained by subtracting a transmission/distribution fee and a service fee from a value obtained by multiplying a power purchase agreement (PPA) unit price by the power capacity to be purchased. When the electric power to be purchased is general electric power, the trading price may be a value obtained by subtracting a transmission/distribution fee and a service fee from a value obtained by multiplying a preset unit price by the power capacity to be purchased.

According to an example embodiment of the present disclosure, eco-friendly electric power and general electric power may be separately stored, and the eco-friendly electric power and the general electric power may be separately traded according to an electric power trading request, thereby inducing voluntary participation in the RE100 campaign.

### BRIEF DESCRIPTION OF DRAWINGS

The above and other aspects, features, and advantages of the present disclosure may be understood from the following detailed description, taken in conjunction with the accompanying drawings.

FIG. 1 is a diagram illustrating a system including a consumer facility and a service platform for electric power trading according to an example embodiment of the present disclosure.

FIG. 2A is a diagram illustrating first state information of a first energy storage system (ESS) included in a vehicle according to an example embodiment of the present disclosure.

FIG. 2B is a diagram illustrating state information of a second ESS included in a service platform according to an example embodiment of the present disclosure.

FIG. 3 is a flowchart illustrating a power trading method between a vehicle and a service platform according to an example embodiment of the present disclosure.

FIG. 4 is a flowchart illustrating a power trading method between a vehicle and a service platform according to an example embodiment of the present disclosure.

FIG. 5 is a block diagram illustrating a computing device capable of implementing a control unit of a vehicle and a control unit of a service platform according to an example embodiment of the present disclosure.

### DETAILED DESCRIPTION

Hereinafter, specific example embodiments of the present disclosure will be described with reference to the accompanying drawings. The following detailed description is provided to aid in understanding a method, an apparatus, and/or a system described in the present disclosure. The detailed description is for illustrative purposes, and the present disclosure is not limited thereto.

In describing the example embodiments of the present disclosure, when it is determined that a detailed description of a known technology related to the present disclosure may obscure the gist of the present disclosure, the detailed description thereof may be omitted. In addition, terms to be described below are terms defined in consideration of functions in the present disclosure, which may vary depending on the intention or custom of a user or operator. Therefore, these terms may be made based on the contents throughout the present specification. The terminology used herein is for the purpose of describing particular example embodiments and is not to be limiting of the example embodiments. As used herein, the singular forms “a,” “an,” and “the” are intended to include the plural forms as well, unless the context indicates otherwise. As used herein, the term “and/or” includes any one and any combination of any two or more of the associated listed items. It may be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

In the present disclosure, a consumer facility may refer to a facility including an energy storage system (ESS), the facility owned by an electric power consumer capable of purchasing eco-friendly electric power and general electric power and then storing the eco-friendly electric power and the general electric power in the ESS. The consumer facility may include a factory of a company, a building, a hospital, and the like.

In the present disclosure, the consumer facility may include a vehicle. The vehicle may be an eco-friendly vehicle including a high-voltage battery and a motor, and may include, for example, a pure electric vehicle, a hybrid vehicle, a plug-in hybrid vehicle, and the like. The eco-friendly vehicle may be a vehicle including a solar panel. Further, the vehicle may be capable of generating eco-friendly electric power using solar power, and the vehicle may also be a vehicle capable of generating eco-friendly electric power using regenerative braking.

In addition, in the present disclosure, a service platform may refer to a facility including an energy storage facility. The facility may be capable of purchasing eco-friendly electric power or general electric power and then storing the eco-friendly electric power or the general electric power in the energy storage facility. The facility may be owned by an electric power operator capable of separately selling the eco-friendly electric power and the general electric power stored in the energy storage facility.

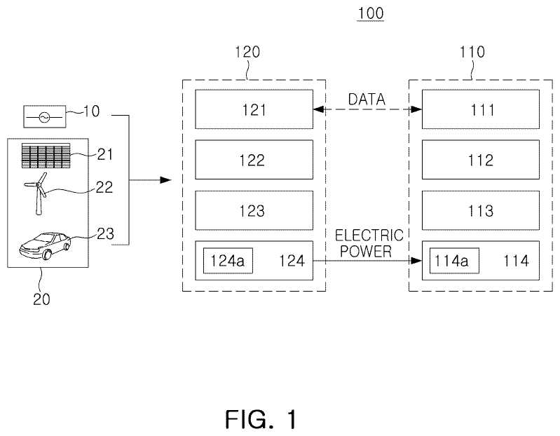

FIG. 1 is a diagram illustrating an (e.g., entire) system 100 including a consumer facility and a service platform for electric power trading according to an example embodiment of the present disclosure.

As illustrated in FIG. 1, a consumer facility 110 may include a communication unit 111, a control unit 112, a storage unit 113, and a first ESS (ESS) 114.

The communication unit 111 may transmit and receive various pieces of data to and from a service platform 120 under the control of the control unit 112.

The control unit 112 may transmit service registration information for electric power trading to the service platform 120. When a service registration confirmation is received from the service platform 120, the control unit 112 may transmit an electric power trading request to the service platform 120.

Thereafter, electric power, corresponding to a power capacity to purchase, may be withdrawn from a second ESS 124 (to be described herein) included in the service platform 120, and may be stored in a second ESS 114 included in the consumer facility 110.

Here, the service registration information may include at least one of registrant information including a service registrant and a code of the registrant, and cooling performance information including cooling performance of the first ESS 114. Here, the cooling performance information may be cooling performance of a cooling system or an air conditioning system for cooling the first ESS 114.

For example, when the consumer facility 110 is a vehicle, the first ESS 114 may be referred to as a high-voltage battery. In this case, the cooling performance information described above may refer to cooling performance information including cooling performance of the high-voltage battery, and the service registration information may further include vehicle information including a manufacturer and a year of the vehicle in addition to the registrant information.

Herein, when the consumer facility 110 is a vehicle, state information of the high-voltage battery may be used interchangeably as battery management system (BMS) information.

The electric power trading request may include electric power to purchase, among eco-friendly electric power and general electric power, and a power capacity to purchase.

Here, the eco-friendly electric power may refer to electric power, generated and stored by a renewable energy source. The renewable energy source may include, for example, solar power and wind power. For example, when the consumer facility 110 is a vehicle, the renewable energy source may include regenerative braking. To this end, the vehicle may include a solar panel, and may include a motor to provide (e.g., enable) regenerative braking.

The general electric power may refer to power, generated and stored using a fossil fuel, and may be electric power charged by one of rapid charging, slow charging, and overnight charging by electric power supplied from a charger.

In addition, when a request for first state information is requested from the service platform 120, the control unit 112 may transmit the first state information to the service platform 120. Thereafter, purchasable power capacity information may be received from the service platform 120.

The first state information, state information of the first ESS 114, may include a TPC, a RPC of the eco-friendly electric power, and a RPC of general electric power in addition to information including a temperature and a state of charge (SOC) of the first ESS 114. Herein, the first state information may also be referred to as BMS information.

In addition, the purchasable power capacity information may include a power capacity (unit: kWh) of each of eco-friendly electric power and general electric power, stored in the second ESS 124.

In addition, the control unit 112 may request unit price information for each unit of electric power (unit: KRW/kWh) from the service platform 120, and may receive the unit price information for each unit of electric power from the service platform 120. Here, the unit price information for each unit of electric power may include a unit price of each of the eco-friendly electric power and the general electric power.

In addition, the control unit 112 may pay a trading price to the service platform 120. Here, the trading price may vary depending on a type of electric power.

For example, when the electric power to purchase is eco-friendly electric power, the trading price may be a value obtained by adding a transmission/distribution fee and a service fee to a value obtained by multiplying a power purchase agreement (PPA) unit price by the power capacity to purchase.

For example, when the electric power to purchase is general electric power, the trading price may be a value obtained by subtracting a transmission/distribution fee and a service fee from a value obtained by multiplying a preset unit price by the power capacity to purchase.

The storage unit 113 may store various pieces of data such as a program or service authentication information for implementing various operations of the control unit 112 described above. Although the service authentication information is described as being stored in the storage unit 113, the service authentication information may be stored in an additional database.

The first ESS 114, a device for storing eco-friendly electric power and general electric power, may be, for example, a device for storing electric power using various battery technologies such as a lithium-ion battery, a lead-acid battery, and/or the like.

The first ESS 114 may include a first state information storage unit 114a for storing the first state information. Here, the first state information may further include a TPC, a RPC of the eco-friendly electric power, and a RPC of the general electric power in addition to information including a temperature and an SOC of the first ESS 114.

The (e.g., above-described) first state information may be updated by the control unit 112 of the consumer facility 110 or updated by the service platform 120 to be described below, and may be provided to the consumer facility 110.

That is, the control unit 112 may verify a type of electric power (e.g., eco-friendly electric power or general electric power) being charged while a charging operation is performed, and may store, in the first state information storage unit 114a, information on the type and a power capacity of electric power being charged. For example, when the electric power being charged is eco-friendly electric power, the electric power may be labeled as “1,” and when the electric power being charged is general electric power, the electric power may be labeled as “0,”thereby verifying the electric power being charged.

Similarly, the control unit 112 may verify a type of electric power (e.g., eco-friendly electric power or general electric power) being discharged while a discharging operation is performed, and may store, in the first state information storage unit 114a, information on the type and a power capacity of electric power being discharged. For example, when the electric power being discharged is eco-friendly electric power, the electric power may be labeled as “1,” and when the electric power being discharged is general electric power, the electric power may be labeled as “0,” thereby verifying the electric power being discharged.

According to an example embodiment of the present disclosure, the consumer facility 110 may be a vehicle. In this case, when the first ESS 114 is discharged due to driving of a motor or driving of an electrical load, the control unit 112 may subtract, according to a predetermined priority between the eco-friendly electric power and the general electric power, a power capacity (e.g., required) to drive the motor or a power capacity (e.g., required) to drive the electrical load from a RPC of corresponding electric power.

For example, when a priority of discharging is set in the order of general electric power to eco-friendly electric power, a power capacity of electric power, corresponding to the general electric power, may first be deducted when a discharging operation is performed. Thereafter, when the power capacity of the electric power, corresponding to the general electric power, is fully consumed, a power capacity of electric power, corresponding to the eco-friendly electric power, may be deducted. Such a configuration is an example embodiment of the present disclosure. A ratio between the general electric power and the eco-friendly electric power may be set, and a power capacity may be deducted according to the ratio.

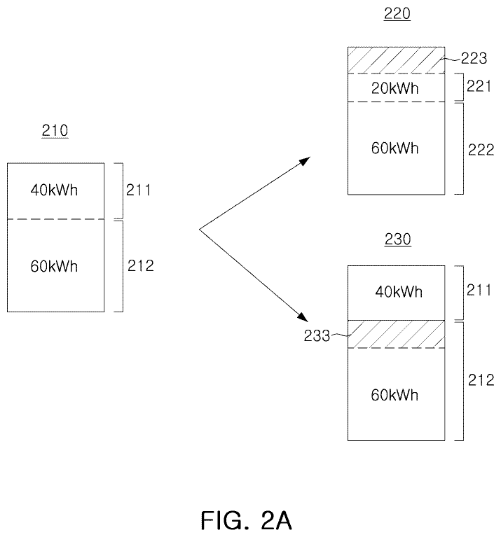

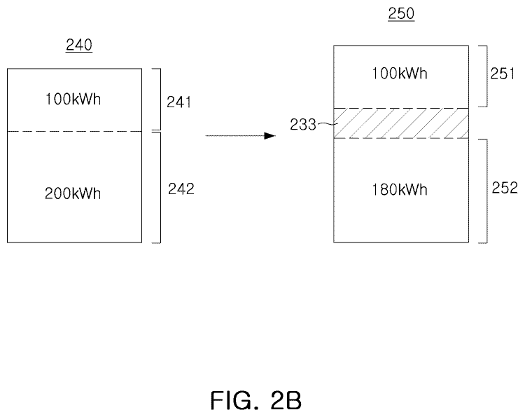

FIG. 2A is a diagram illustrating first state information of a first ESS included in a vehicle according to an example embodiment of the present disclosure. Reference numeral 210 denotes a current power capacity of the first ESS 114, reference numeral 220 denotes a RPC of the first ESS 114 when a motor or an electrical load is driven in a case in which a priority is set in the order of general electric power to eco-friendly electric power, and reference numeral 230 denotes a RPC of the first ESS 114 in a case in which electric power to be purchased is set as eco-friendly electric power when electric power trading is requested.

As illustrated in reference numeral 210 of FIG. 2A, the current power capacity 210 of the first ESS 114 may be 40 kWh for general electric power 211 and 60 kWh for eco-friendly electric power 212.

As illustrated in reference numeral 220 of FIG. 2A, when 20 kWh of electric power 223 is consumed when the motor or the electrical load is driven, the general electric power may first be deducted. Accordingly, a RPC after the motor or the electrical load is driven may be 20 kWh for the general electric power 221 and 60 kWh for the eco-friendly electric power 222.

As illustrated in reference numeral 230 of FIG. 2A, when electric power to be purchased is set as eco-friendly electric power in an electric power trading request, the electric power to be purchased may be added to the eco-friendly electric power. Accordingly, when 20 kWh of electric power 233 is purchased, a RPC may be 40 kWh for the general electric power 231 and 80 kWh for the eco-friendly electric power 232.

The service platform 120 may include a communication unit 121, a control unit 122, a storage unit 123, and an ESS 124.

The communication unit 121 may transmit and receive various pieces of data to and from the consumer facility 110 under the control of the control unit 122.

The control unit 122 may receive service registration information from the consumer facility 110, and may transmit a service registration confirmation to the consumer facility 110 in response to the received service registration information. The service registration confirmation may be transmitted when service registration information stored in a storage unit 123 to be described below corresponds to the service registration information received from the consumer facility 110.

Thereafter, when the electric power trading request is received from the consumer facility 110, the control unit 122 may withdraw electric power corresponding to a power capacity to be purchased included in the electric power trading request, from the second ESS 124, and may store the electric power in the first ESS 114 included in the consumer facility 110.

The above-described service registration information may include at least one of registrant information including a service registrant and a code of the registrant, and cooling performance information including cooling performance of the first ESS 114. Here, the cooling performance information may be cooling performance of a cooling system or an air conditioning system for cooling the first ESS 114, as described above.

In addition, the control unit 122 may limit a withdrawal speed of power withdrawn from the second ESS 114, based on the cooling performance information and a temperature of the first ESS 114.

The control unit 122 may request first state information of the first ESS 114 from the consumer facility 110. When the first state information is received from the consumer facility 110, the control unit 122 may transmit purchasable power capacity information based on the first state information.

Here, the purchasable power capacity information may include a power capacity of each of eco-friendly electric power and general electric power, stored in the second ESS 124, as described above.

In addition, the control unit 122 may update the first state information of the first ESS 114, transmit the updated first state information to the consumer facility 110, and update state information of the second ESS 124.

In addition, the control unit 122 may transmit unit price information for each unit of electric power to the consumer facility 110. The unit price information for each unit of electric power may include a unit price of each of eco-friendly electric power and general electric power, as described above.

In addition, the control unit 122 may request a trading price from a user of the consumer facility 110. Here, the trading price may vary depending on a type of electric power.

For example, when the electric power to purchase is eco-friendly electric power, the trading price may be a value obtained by adding a transmission/distribution fee and a service fee to a value obtained by multiplying a PPA unit price by the power capacity to be purchased.

For example, when the electric power to purchase is general electric power, the trading price may be a value obtained by adding a transmission/distribution fee and a service fee to a value obtained by multiplying a preset unit price by the power capacity to be purchased, as described above.

The storage unit 123 may store various pieces of data such as a program or service authentication information for implementing various operations of the control unit 122 described above. Although the service authentication information is described as being stored in the storage unit 123, the service authentication information may be stored in an additional database.

The second ESS 124, a device for storing eco-friendly electric power and general electric power, may be, for example, a device for storing electric power using various battery technologies such as a lithium-ion battery, a lead-acid battery, and the like.

The second ESS 124 may include a second state information storage unit 124a for storing second state information of the second ESS 124. Here, the state information of the second ESS 124 may include a TPC, a RPC of the eco-friendly electric power, and a RPC of the general electric power in addition to information including a temperature and an SOC of the second ESS 124.

FIG. 2B is a diagram illustrating state information of a second ESS included in a service platform according to an example embodiment of the present disclosure. Reference numeral 240 denotes a current power capacity of the second ESS 124, and reference numeral 250 denotes a RPC of the ESS 114 after electric power is withdrawn in response to an electric power trading request.

As illustrated in reference numeral 240 of FIG. 2B, a current power capacity 240 of the second ESS 124 may be 100 kWh for general electric power 241 and 200 kWh for eco-friendly electric power 242.

As illustrated in reference numeral 250 of FIG. 2B, when 20 kWh of eco-friendly electric power is purchased according to an electric power trading request, a RPC of the second ESS 124 may be 100 kWh for general electric power 251 and 180 kWh for eco-friendly electric power 252.

Referring back to FIG. 1, the second ESS 124 may store various types of electric power.

For example, the second ESS 124 may receive and store general electric power from a charger 10. The general electric power, electric power generated and stored using a fossil fuel, may be electric power charged by one of rapid charging, slow charging, and overnight charging.

In addition, the second ESS 124 may receive and store eco-friendly electric power from an eco-friendly facility 20 such as a solar panel 21, a wind power facility 22, or an eco-friendly vehicle 23. The solar panel 21 may provide solar power, the wind power facility 22 may provide wind power, and the eco-friendly vehicle 23 may provide eco-friendly electric power, generated by using regenerative braking using a motor or solar power using a solar panel as a renewable energy source, to the second ESS 124.

As described above, according to an example embodiment of the present disclosure, eco-friendly electric power and general electric power may be separately stored, and the eco-friendly electric power and the general electric power are separately traded according to an electric power trading request, thereby inducing participation in the RE 100 campaign.

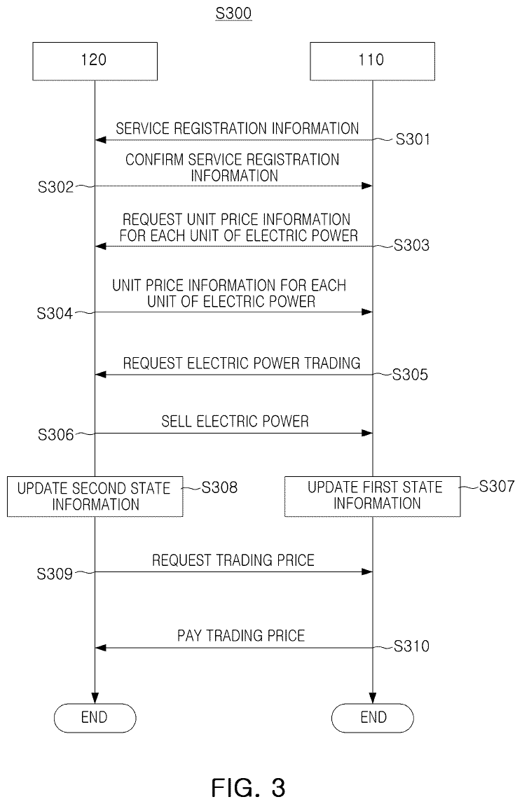

FIG. 3 is a flowchart illustrating a power trading method between a vehicle and a service platform according to an example embodiment of the present disclosure.

Hereinafter, an electric power trading method between a vehicle and a service platform according to an example embodiment of the present disclosure is described with reference to FIG. 3. However, for simplicity of the present disclosure, descriptions overlapping those of FIGS. 1 to 2B may be omitted.

Referring to FIG. 3, an electric power trading method (S300) between a vehicle and a service platform according to an example embodiment of the present disclosure may be started by an operation of transmitting service registration information for electric power trading from a consumer facility 110 to a service platform 120 (S301).

The service registration information may include at least one of registrant information including a service registrant and a code of the registrant, and cooling performance information including cooling performance of a first ESS 114. Here, the cooling performance information may be cooling performance of a cooling system or an air conditioning system for cooling the first ESS 114.

For example, when the consumer facility 110 is a vehicle, the first ESS 114 may be referred to as a high-voltage battery. In this case, the cooling performance information described above may refer to cooling performance information including cooling performance of the high-voltage battery, and the service registration information may further include vehicle information including a manufacturer and a year of the vehicle in addition to the registrant information, as described above.

The service platform 120 may determine whether the received service registration information corresponds to pre-stored service registration information, and may transmit a service registration confirmation to the consumer facility 110 when the received service registration information corresponds to the pre-stored service registration information (S302).

Thereafter, the consumer facility 110 may request unit price information for each unit of electric power from the service platform 120 (S303), and the service platform 120 may transmit unit price information for each unit of electric power (unit: KRW/kWh) to the consumer facility 110 (S304). Here, the unit price information for each unit of electric power may include a unit price of each of eco-friendly electric power and general electric power, as described above.

Thereafter, the consumer facility 110 may transmit an electric power trading request to the service platform 120 (S305). The electric power trading request may include electric power to purchase, among the eco-friendly electric power and the general electric power, and a power capacity to purchase, as described above.

Thereafter, electric power may be sold from the service platform 120 to the consumer facility 110 (S306). Specifically, the service platform 120 may withdraw electric power having a power capacity, corresponding to the power capacity to purchase, and may store the electric power in the first ESS 114 included in the consumer facility 110.

Thereafter, the consumer facility 110 may update the first state information (S308).

Here, the first state information may further include a TPC, a RPC of the eco-friendly electric power, and a RPC of the general electric power in addition to information including a temperature and an SOC of the first ESS 114, as described above.

Similarly, the service platform 120 may update state information of the second energy storage system (S307).

Here, the state information of the second energy storage system may include a TPC, a RPC of the eco-friendly electric power, and a RPC of the general electric power in addition to information including a temperature and an SOC of the energy storage system, as described above.

Finally, the service platform 120 may request a trading price from the consumer facility 110 (S309), and the consumer facility 110 may pay the trading price to the service platform 120 (S310).

Here, the trading price may vary depending on a type of electric power, as described above.

For example, when the electric power to purchase is eco-friendly electric power, the trading price may be a value obtained by adding a transmission/distribution fee and a service fee to a value obtained by multiplying a PPA unit price by the power capacity to purchase.

For example, when the electric power to purchase is general electric power, the trading price may be a value obtained by adding a transmission/distribution fee and a service fee to a value obtained by multiplying a preset unit price by the power capacity to purchase, as described above.

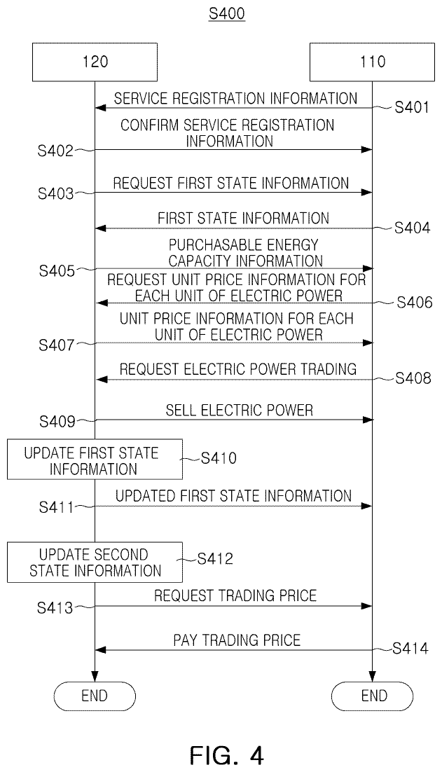

FIG. 4 is a flowchart illustrating a power trading method between a vehicle and a service platform according to an example embodiment of the present disclosure. FIG. 4 may differ from FIG. 3 in that operations S405, S410, and S411 are further included.

Referring to FIG. 4, an electric power trading method (S400) between a vehicle and a service platform according to an example embodiment of the present disclosure may be started by an operation of transmitting service registration information for electric power trading from a consumer facility 110 to a service platform 120 (S401).

The service platform 120 may determine whether the received service registration information corresponds to pre-stored service registration information, and may transmit a service registration confirmation to the consumer facility 110 when the received service registration information corresponds to the pre-stored service registration information (S402).

Thereafter, the service platform 120 may request first state information from the consumer facility 110 (S403), and the consumer facility 110 may transmit the first state information to the service platform 120 (S404).

Thereafter, the service platform 120 may transmit purchasable power capacity information to the consumer facility 110. Here, the purchasable power capacity information may include a power capacity of each of eco-friendly electric power and general electric power, as described above.

Thereafter, the consumer facility 110 may request unit price information for each unit of electric power from the service platform 120 (S406), and the service platform 120 may transmit the unit price information for each unit of electric power (unit: KRW/kWh) to the consumer facility 110 (S407).

Thereafter, the consumer facility 110 may transmit an electric power trading request to the service platform 120 (S408).

Thereafter, electric power may be sold from the consumer facility 110 to the service platform 120 (S409). Specifically, the service platform 120 may withdraw electric power corresponding to a power capacity to be purchased, and may store the electric power in the first ESS 114 included in the consumer facility 110.

Thereafter, the service platform 120 may update the first state information (S410), and may transmit the updated first state information to the consumer facility 110 (S411).

Thereafter, the service platform 120 may update state information of the second energy storage system (S412).

Finally, the service platform 120 may request a trading price from the consumer facility 110 (S413), and the consumer facility 110 may pay the trading price to the service platform 120 (S414).

As described above, according to an example embodiment of the present disclosure, eco-friendly electric power and general electric power may be separately stored, and the eco-friendly electric power and the general electric power are separately traded according to an electric power trading request, thereby inducing participation in the RE100 campaign.

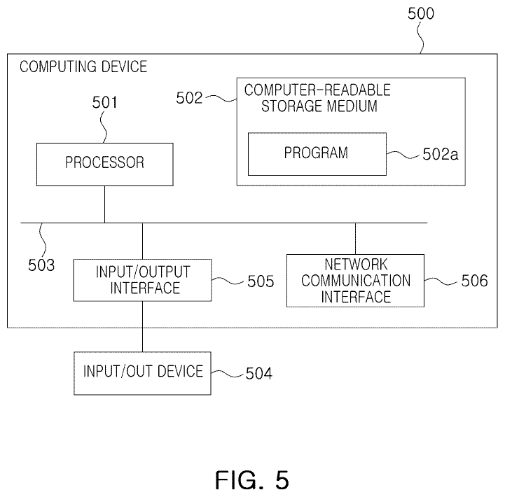

FIG. 5 is a block diagram of a computing device capable of fully or partially implementing a control unit 112 of a vehicle and a control unit 122 of a service platform according to an example embodiment of the present disclosure.

As illustrated in FIG. 5, the computing device 500 may include at least one processor 501, a computer-readable storage medium 502, and a communication bus 503.

The processor 501 may cause the computing device 500 to operate according to the example embodiments described above. For example, the processor 501 may execute one or more programs stored in the computer-readable storage medium 502. The one or more programs may include one or more computer-executable instructions. When executed by the processor 501, the one or more computer-executable instructions may be configured to cause the computing device 500 to perform operations according to example embodiments.

The computer-readable storage medium 502 may be configured to store the computer-executable instructions or program code, program data, and/or other suitable forms of information. A program 502a, stored in the computer-readable storage medium 502, may include a set of instructions executable by the processor 501. In an example embodiment, the computer-readable storage medium 502 may be a memory (e.g., a volatile memory such as a random access memory, a non-volatile memory, or any suitable combination thereof), one or more magnetic disk storage devices, optical disk storage devices, flash memory devices, other types of storage media that are accessible by the computing device 500 and are capable of storing (e.g., desired) information, or any suitable combinations thereof.

The communication bus 503 may interconnect various other components of the computing device 500, including the processor 501 and the computer-readable storage medium 502.

The computing device 500 may also include one or more input/output interfaces 505 providing an interface for one or more input/output devices 504, and one or more network communication interfaces 506. The input/output interface 505 and the network communication interface 506 may be connected to the communication bus 503. A network may be one of a cellular network, for example, a global system for mobile communications (GSM), an enhanced data rate for GSM evolution (EDGE), a general packet radio service (GPRS), a code division multiple access (CDMA), a time division-CDMA (TD-CDMA), a universal mobile telecommunications system (UMTS), or long-term evolution (LTE), or another cellular network.

The input/output device 504 may be connected to other components of the computing device 500 through the input/output interface 505. The example input/output device 504 may include a pointing device (e.g., a mouse or trackpad), a keyboard, a touch input device (e.g., a touchpad or touchscreen), a voice or sound input device, input devices such as various types of sensor devices and/or photographing devices, and/or output devices such as a display device, a printer, a speaker, and/or a network card. The example input/output device 504 may be included in the computing device 500 as a component included in the computing device 500, or may be connected to the computing device 500 as a device, distinct from the computing device 500.

Example embodiments of the present disclosure may include a program for performing the methods described herein on a computer, and a computer-readable recording medium including the program. The computer-readable recording medium may include, alone or in combination with program instructions, local data files, local data structures, and the like. The medium may be those specially designed and constructed for the purposes of the example embodiments, or may be of the well-known kind and available to those having skill in the computer software arts. Examples of the computer-readable medium include magnetic media such as hard disks, floppy disks, and magnetic tape, optical media such as CD ROM discs and DVDs, magneto-optical media such as optical discs, and hardware devices that are specially configured to store and perform program instructions, such as read-only memory (ROM), random access memory (RAM), flash memory, and the like. Examples of the program may include both a machine code, such as a code produced by a compiler, and a higher-level code that may be executed by the computer using an interpreter.

While example embodiments have been shown and described above, it may be apparent to those skilled in the art that modifications and variations could be made without departing from the scope of the present disclosure as defined by the appended claims.

What is claimed is:

1. A consumer facility for electric power trading, the consumer facility comprising:
one or more processors; and
a storage medium configured to store a computer-readable instruction,
wherein, when the computer-readable instruction is executed by the one or more processors, the one or more processors are configured to
transmit service registration information for electric power trading, and
transmit an electric power trading request, the electric power trading request including electric power to purchase, among eco-friendly electric power and general electric power, and a power capacity to purchase, when a service registration confirmation is received in response to transmission of the service registration information,
wherein electric power corresponding to the power capacity to purchase is withdrawn from a service platform according to the electric power trading request.

2. The consumer facility of claim 1, further comprising:
a first energy storage system (ESS) configured to store the eco-friendly electric power and the general electric power; and
a first state information storage unit configured to store first state information of the first ESS,
wherein the first state information includes a total power capacity (TPC), a remaining power capacity (RPC) of the eco-friendly electric power, and a RPC of the general electric power in addition to information including a temperature and a state of charge (SOC) of the first ESS.

3. The consumer facility of claim 2, wherein
the service registration information includes cooling performance information on the first ESS, and
a withdrawal speed of electric power withdrawn from the service platform is limited based on the cooling performance information and the temperature of the first ESS.

4. The consumer facility of claim 2, wherein the one or more processors are configured to update the first state information.

5. The consumer facility of claim 2, wherein the one or more processors are configured to:
receive a request for the first state information;
transmit the first state information in response to the received request for the first state information; and
receive purchasable power capacity information, the purchasable power capacity information including a power capacity of each of the eco-friendly electric power and the general electric power, after the first state information is transmitted.

6. The consumer facility of claim 5, wherein the one or more processors are configured to receive updated first state information.

7. The consumer facility of claim 1, wherein the one or more processors are configured to:
request unit price information for each unit of electric power, the unit price information for each unit of electric power including a unit price of each of the eco-friendly electric power and the general electric power; and
receive the unit price information for each unit of electric power, after the unit price information for each unit of electric power is requested.

8. The consumer facility of claim 1, wherein
the eco-friendly electric power is electric power, generated and stored by a renewable energy source, and
the general electric power is electric power, generated and stored using a fossil fuel.

9. The consumer facility of claim 8, wherein the general electric power is electric power, charged by one of rapid charging, slow charging, or overnight charging.

10. The consumer facility of claim 8, wherein the renewable energy source is at least one of solar power and regenerative braking.

11. The consumer facility of claim 2, wherein the service registration information includes at least one of registrant information including a service registrant and a code of a registrant, and cooling performance information including cooling performance of the first ESS.

12. The consumer facility of claim 10, wherein the consumer facility is a vehicle including a solar panel for generating electric power by solar power.

13. The consumer facility of claim 12, wherein the one or more processors are configured to subtract, according to a predetermined priority between the eco-friendly electric power and the general electric power, a power capacity to drive a motor or a power capacity to drive an electrical load from a remaining power capacity of corresponding electric power, when the motor or the electrical load is driven.

14. The consumer facility of claim 12, wherein the service registration information further includes vehicle information including a manufacturer and a year of the vehicle.

15. A service platform for electric power trading, the service platform comprising:
one or more processors; and
a storage medium configured to store a computer-readable instruction,
wherein, when the computer-readable instruction is executed by the one or more processors, the one or more processors are configured to
receive service registration information,
transmit a service registration confirmation in response to the received service registration information,
receive an electric power trading request, the electric power trading request including electric power to be purchased by a consumer facility, among eco-friendly electric power and general electric power, and a power capacity to be purchased, after the service registration confirmation is transmitted, and
withdraw electric power corresponding to the power capacity to be purchased, according to the electric power trading request.

16. The service platform of claim 15, further comprising:
a second energy storage system (ESS) configured to store the eco-friendly electric power and the general electric power; and
a second state information storage unit configured to store state information of the second ESS,
wherein the second state information includes a total power capacity (TPC), a remaining power capacity (RPC) of the eco-friendly electric power, and a remaining power capacity (RPC) of the general electric power in addition to information including a temperature and an SOC of the second ESS.

17. The service platform of claim 16, wherein
the service registration information includes cooling performance information a first ESS included in the consumer facility, and
the one or more processors are configured to limit a withdrawal speed of electric power withdrawn from the first ESS, based on the cooling performance information and a temperature of the first ESS.

18. The service platform of claim 17, wherein the one or more processors are configured to:
update first state information of the first ESS; and
transmit the updated first state information to the consumer facility.

19. The service platform of claim 16, wherein the one or more processors are configured to:
receive a request for unit price information for each unit of electric power, the unit price information for each unit of electric power including a unit price of each of the eco-friendly electric power and the general electric power; and
transmit the unit price information for each unit of electric power in response to the request.

20. The service platform of claim 16, wherein
the one or more processors are configured to:
request a trading price from the consumer facility; and
receive the trading price from the consumer facility,
when the electric power to be purchased is eco-friendly electric power, the trading price is a value obtained by subtracting a transmission/distribution fee and a service fee from a value obtained by multiplying a power purchase agreement (PPA) unit price by the power capacity to be purchased, and
when the electric power to be purchased is general electric power, the trading price is a value obtained by subtracting a transmission/distribution fee and a service fee from a value obtained by multiplying a preset unit price by the power capacity to be purchased.
